(19) United States
(12) Patent Application Publication
(10) Pub. No.: US 2011/0167049 A1
(43) Pub. Date: Jul. 7, 2011

(54) FILE SYSTEM MANAGEMENT TECHNIQUES FOR COMPUTING ENVIRONMENTS AND SYSTEMS

(75) Inventor: Shachar RON, Sunnyvale, CA (US)

(73) Assignee: APPLE INC., Cupertino, CA (US)

(21) Appl. No.: 12/652,617

(22) Filed: Jan. 5, 2010

(51) Int. Cl. G06F 17/00; G06F 12/00; G06F 11/00

(52) U.S. Cl. 707/690; 707/822; 714/21; 707/E17.01; 713/2; 714/E11.133

(57) ABSTRACT

Disclosed file system management techniques can augment and/or enhance a file management system (e.g., a conventional file system) provided for organizing data stored in computer readable storage medium (e.g., a HDD). Data and metadata can be written to a file system space of a file system without using a file management system and without incorporating the data into the file system. However, the metadata can include information allowing the written data to be (later) incorporated into the file system and without having to use the file system, thereby allowing write performance to be enhanced. Generally, metadata can provide additional information including data (e.g., integrity data) that cannot be provided or efficiently provided by the file management system to augment a limited or reduced file system. Integrity data can be especially useful for error recovery (e.g., after a system failure).

### BACKGROUND

Conceptually, a computing system (e.g., a computing device, a personal computer, a laptop, a Smartphone, a mobile phone) can accept information (content or data) and manipulate it to obtain or determine a result based on a sequence of instructions (or a computer program) effectively describing how to process the information. Typically, the information is stored in a computer readable medium in a binary form. More complex computing systems can store content including the computer program itself. A computer program may be invariable and/or built into, for example, a computer (or computing) device as logic circuitry provided on microprocessors or computer chips. Today, general purpose computers can have both kinds of programming. Storing content (or information retention) is of one the core functions of computing devices. Today, numerous types of computing devices are available. These computing devices widely range with respect to size, cost, amount of storage and processing power. The computing devices that are available today include: expensive and powerful servers, relatively cheaper Personal Computers (PC's) and laptops, and yet less expensive microprocessors (or computer chips) provided in storage devices, automobiles, and household electronic appliances. Memory and storage devices have long been an important part of computing and computing devices. Memory and storage device technology have been markedly improved in recent years. Today, relatively large amounts of content can be stored in portable and easy to access devices such as USB flash drives (or USB flash devices). The content stored on USB flash drives can be easily carried and copied on to various computing devices. By way of example, data stored on a server computer can be copied on to a USB flash drive and taken home and loaded (or copied) on to a Personal Computer (PC).

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as a handheld computer or simply a handheld) can be a pocket-sized computing device, typically utilizing a small visual display screen for user output and a miniaturized keyboard for user input. In the case of a Personal Digital Assistant (PDA), the input and output can be combined into a touch-screen interface. In particular, mobile communication devices (e.g., mobile phones) and portable media players (e.g., the iPod® available from Apple Inc.) have become extremely popular. Some mobile devices (e.g., the iPhone® also from Apple Inc.) offer computing environments that are similar to that provided by a Personal Computer (PC). As such, a mobile device can effectively provide a complete standardized interface and platform for application developers.

As generally known in the art, a computing system can have a support system to manage various resources (e.g., memory, peripheral devices) and services (e.g., basic functions such as opening files) and allow the resources to be shared among multiple programs. One such support system is generally known as an Operating System (OS), which provides programmers with an interface used to access these resources and services. Most operating systems provide a file system as an integral part of a computing system. A file system (or a filesystem) can store and organize data as computer files making it easier to find and access the data. A file system may use a data storage device (or a storage device) such as, for example, a Hard Disk Drive (HDD), CD-ROM, or a Flash Drive (FD). File systems, such as, File Allocation Table (FAT) and Hieratical File Systems (HFS) are generally well known. Live File Systems (LFS) have been recently developed. LFS can effectively turn a less flexible storage medium (e.g., a Digital Video Disc (DVD), a Compact Disk (CD)) into a more flexible storage device (e.g., a Flash Drive). In other words, LFS allow writing to DVD's and CD's as if they were a Flash Drive.

In view of the foregoing, it is apparent that file systems are an important aspect of computing and are widely used in various computing systems and storage devices. However, some file systems provide limited or reduced capabilities. Limited or reduced file systems are generally more conventional file systems. As such, a limited or reduced file system may be more prevalent in more conventional systems and can be relatively less expensive and therefore more desirable to use, for example, in a portable mobile device or Consumer Electronic (CE) device. As an example, one limitation of a more conventional file system (e.g., a FAT file system) may be relatively slower system performance than a more modern file system especially when a relatively large amount of data is written to the file system. This is especially problematic, for example, in continuous recording of video requiring several reads of the file system organization information (e.g., reads of block allocation structures) thereby consuming processing time and possibly other resources (e.g., battery power of a mobile device). It should be noted that although caching may be available to reduce the number of reads, caching techniques may be complicated and/or less desirable to implement, especially for mobile devices or when a Live Operating System (LOS) or several clients may be using the file system. As another example, more conventional file systems may also be more susceptible to loss of data and/or data corruption. For example, in a portable device, drain of battery power may force an unexpected shutdown before the file system has been able to incorporate the data into the file system. This situation can be especially problematic when relatively large amounts of data are written, and can result in serious loss or corruption of data.

Also, in more conventional file systems, updating or modifying a file can require several modifications to the file system organization information. In a system with multiple writers operating over a rotating disk excessive delay may be cause when multiple files are simultaneously used. These and other considerations may suggest writing larger amounts of data more infrequently. However, as a result, larger buffer consumption may result, as well as the likelihood of losing more data in case of a system failure. This can be problematic especially in more memory constrained devices or when there is less tolerance for losing data or data corruption.

In view of the foregoing and the importance of file systems to computing and storage technologies, improved file system management techniques would be very useful.

### SUMMARY

This paper describes various embodiments relating to computing systems and computing environments. It can be appreciated that the embodiments described herein can augment or otherwise enhance a conventional file management system used for organizing data stored in a storage media. The storage media can take many forms such as, for example, a hard disk drive (HDD), a FLASH memory that can, in turn, include FLASH based mass storage device as well as a FLASH memory card.

In accordance with one embodiment, a method implemented by a computing system is described. The computing system includes at least a file system for storing data files and the file system is managed by a first file management system. The method can be performed by carrying out at least the following operations. A second file management system different from the first file management system writes data and metadata to a file system space of the file system. In the described embodiment, at least some of the metadata is used to incorporate the written data into the file system for management by the first file management system.

In accordance with another embodiment, a computing system is described. The computing system includes at least a data storage device arranged to store data files as a file system managed by a first file management system. The computing system also includes a processor coupled to the data storage device. In the described embodiment, the processor is configured to write data and metadata to a file system space of the file system using a second file management system different from the first file management system. The processor is also configured to use the second file management system to use at least some of the metadata to incorporate the written data into the file system for management by the first file management system.

In yet another embodiment, a computer readable storage medium storing at least executable computer code for managing a file system by a first file management system and a second file management system that are different from each other is described. The executable computer code includes at least executable computer code to write data and metadata to a file system space of the file system using the second file management system. In the described embodiment, at least some of the metadata is used to incorporate the written data into the file system for management by the first file management system. The computer readable storage medium also includes executable computer code for reserving a portion of the file system space as a reserved file system space into which only the second file management system is permitted to write the data and the metadata. It should be noted, however, that the first file management system is permitted to write the data and metadata to an unreserved remaining portion of the file system space. The computer readable storage medium further includes executable computer code for writing at least some of the data and metadata to the reserved file system space by the second file management system.

In still another embodiment, a consumer electronic product is described. The consumer electronic product includes at least a data storage device having a file system arranged to store a plurality of data files, the data files being managed by a first file management system and a processor coupled to the data storage device. In the described embodiment, the processor is configured to at least use a second file management system different from the first file management system to write data and metadata to a file system space of the file system. The processor uses at least some of the metadata to incorporate the written data into the file system for management by the first file management system. In one aspect of the described embodiment, the second file management system writes data received from an external data source to the file system while the first file management system is halted. Subsequently, the second file management system updates file system management information thereby enabling the first file management system to manage the data.

Other aspects and advantages of the techniques will become apparent from the following the detailed description, taken in conjunction with the accompanying drawings, illustrating by way of example the principles of file system management techniques.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 depicts a computing environment in accordance with one embodiment.

FIG. 2 depicts a method for managing a file system in accordance with one embodiment.

FIG. 3 depicts a method for managing a file system in accordance with another embodiment.

FIG. 4 depicts a method for managing a file system in accordance with yet another embodiment.

FIG. 5 depicts a method for managing a file system in accordance with still another embodiment.

FIG. 6 depicts a File Management System (FMS) provided for a computing system in accordance with one embodiment.

FIGS. 7-8 depict a number of units of file system storage in a reserved space (or section(s)) of a file system space in accordance with one exemplary embodiment.

FIGS. 9A-9B depict a method for writing to a file system in accordance in one embodiment.

FIG. 10 depicts a method for reserving space in a file system in accordance with one embodiment.

FIG. 11 depicts a method for recovering and incorporating data into a file system in accordance with one embodiment.

FIG. 12 depicts a File Management System (FMS) provided with a conventional file system for a computing device in accordance with one exemplary embodiment.

### DETAILED DESCRIPTION

Improved file system management techniques are disclosed. It will be appreciate that the disclosed file system management techniques, among other things, can augment and/or enhance a file management system (e.g., a conventional file system) provided for organizing (or logically organizing) data stored in computer readable storage medium (e.g., a HDD, a FD).

In accordance with one aspect of the techniques, data and metadata can be written to a file system space of a file system without using a file management system that is operable (or normally operable) to write the data into the file system space. The file management system (e.g., a conventional file system) can be generally operable to effectively manage the data written in its file system space as a part of the file system if the written data has been incorporated into the file system. Data written into the file system space can be incorporated into the file system, for example, by updating file system organization information (e.g., a FAT file system data structure of a FAT file system). Generally, metadata can be provided for the data and can include information not provided by the file management system.

In accordance with another aspect, data and metadata can be written to a file system space of a file system without incorporating the data into the file system and without using a file management system. However, the metadata can include information allowing the data to be incorporated into the file system (possibly without using the file management system) but for management by the file management system. Generally, the file management system can be operable (or normally operable or made operable) to effectively manage data in its file system space and perform file management activities, including incorporation of data into the file system, for example, by updating its file system organization information.

Data and/or metadata can, for example, be written to a reserved file system space where a file management system is inoperable (or has been rendered inoperable) to write data. By way of example, data and metadata can be written to a reserved file system space where a file system is inoperable to write but the file system can be operable to write data to unreserved file system space and effectively manage data in the unreserved file system space. In effect, two file management systems can be operable in the same file system space and can potentially write to the file system space at the same time. As noted above, data and metadata can, for example, be written without updating file system organization information of a conventional file system (e.g., file system data structures of a FAT file system). However, metadata written to a reserved file system space can provide the information needed to later update the file system organization information to effectively incorporate the data into the file system without using the file system. By way of example, another entity (e.g., a second file management system) can effectively halt or suspend a conventional file management system, and use metadata to incorporate the data already present in the file system space, into the file system (or make the data become part of the file system) managed by the conventional file management system. It should be noted that incorporation of data or its reconciliation with the file system can involve effectively returning at least a portion of the reserved file system space back to the file system (e.g., turn the reserved file system space into unreserved file system space). Generally, size and location of the reserved file system can vary and can be managed to accommodate various demands and applications, as will be appreciated by those skilled in the art.

It will be appreciated that without using a file management system, relatively large amounts of data can be written before the data is effectively incorporated into the file system managed by the file management system. The size of the data written in the file system space without incorporation of the data into the file system can be significantly larger that the size of data that can be written using the management system. In other words, data can be written to the file system space of a file system but incorporation of data into the file system can be effectively delayed in comparison to data written by the file management system. As a result, system performance can significantly improve at least partly by incorporating data in relatively larger quantities than a file management system would normally allow. It should also be noted that data can be efficiently incorporated into the file system partly because there is no need to copy the data into the file system as the data can be written directly to the file system space and in a form readily available for incorporation into the file system.

In addition, it will be appreciated that metadata written for data can allow error recovery (or better error recovery) as the metadata can be indicative of data written to and present in the file system space (e.g., a reserved file system space) but not part of the file system. As such, metadata can be used to effectively recover data in various situations including, for example, when there is a system failure (e.g., unexpected shutdown, inappropriate removal of a removable storage device). It should be noted that metadata can be provided in accordance with a desired degree of granularity. By way of example, metadata can be individually provided for each one of nominal storage units of a file system (e.g., each cluster or each block as may be recognized by a file system as a nominal unit to be used to store data as a file) thereby decreasing the likelihood of loss of data without dramatically degrading system performance.

It should be noted that metadata can include integrity verification data (or verification data) allowing verification of the integrity of data written to the file system space. More generally, metadata can include information not provided, information that cannot be provided at all, or information that cannot be effectively or efficiently provided by a file management system in accordance with another aspect. In addition, it will be appreciated that the file management techniques can effectively reduce the number of times file system organization information is updated, thereby decreasing the likelihood of data corruption in case of a system failure.

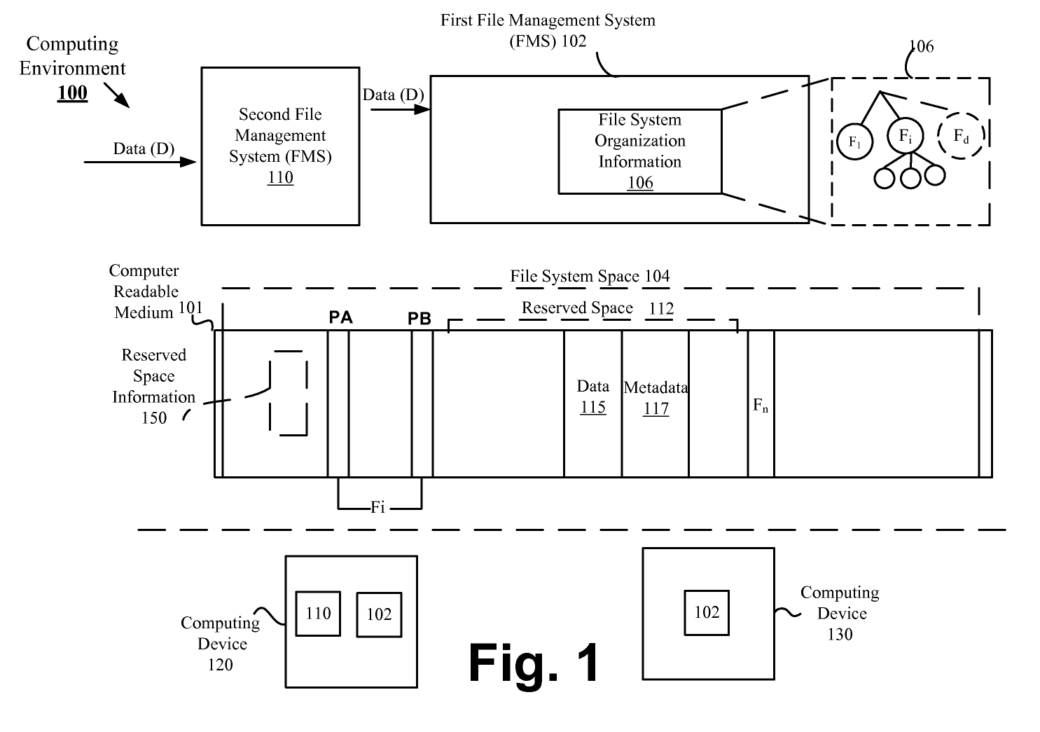

Embodiments of these aspects are discussed below with reference to FIGS. 1-12. However, those skilled in the art will readily appreciate that the detailed description given herein with respect to these figures is for explanatory purposes as the principles of the file system management techniques extend well beyond these limited embodiments.

FIG. 1 depicts a computing environment 100 in accordance with one described embodiment. It will be appreciated that the computing environment 100 can, for example, be provided as or by a computing system 120 (also depicted in FIG. 1). It will also be appreciated that the computing system 120 can, for example, be a Personal Computer (PC), a portable media player, a Smartphone, or a Consumer Electronic (CE) with computing capabilities including execution of executable computer code. Data can be stored in a computer readable storage medium 101 as widely known in the art. Generally, the computer readable storage medium 101 can provide, or be any form of, memory or a memory device including, for example, volatile or non-volatile memory, a Hard Disk Drive (HDD), Flash Memory (FM), as will be readily known by those skilled in the art. As is also known in the art, data can be organized (or logically organized) using a File Management System, such as, for example, a file system (e.g., FAT, HFS). Typically, organized data is stored in non-volatile storage (e.g., a HDD, a Flash Drive).

Referring to FIG. 1, a first File Management System (or component) 102 can be operable to organize data as files (F₁, . . . , Fₙ) in a file system space 104. It should be noted that a file Fᵢ can include multiple data portions or segments (e.g., data blocks, or clusters of data blocks) that need not be written in a continuous space or as continuous data portions or segments in the file system space 104. In other words, a file Fᵢ can include multiple non-continuous physical storage units PA and PB (e.g., data blocks, or clusters of data blocks). As such, a file Fᵢ can be a logical organization of multiple physical data portions, segments, or units. It should be noted that the first File Management System (FMS) 102 can also be operable to generate and maintain information regarding the organization of the files (F₁, . . . , Fₙ) in the file system space 104 as file system organization information 106. By way of example, the file system organization information 106 can effectively represent the organization of files as directories and subdirectories in a form intuitive to a user. It should also be noted that the file system organization information 106 can itself be stored in the file system space 102, for example, in a section reserved for file system data (not shown).

Referring to FIG. 1, an exemplary file system organization information 106 is depicted as a tree including a file F₁, a directory Fᵢ with three (3) unlabeled nodes that can be files or directories (or subdirectories), and a file F_{d}. It should be noted that input data (D) can, for example, be represented as a new file F_{d} in file system organization information 106 after the data has been written to the file system space 104 to effectively incorporate the data in the file system space 104. It should also be noted that the first FMS 102 can, for example, be and/or include a conventional File System (e.g., a FAT 32 file system). Conceptually, a file system can be viewed as organization of files in the file system space 104. As will be appreciated by those skilled in the art, first FMS 102 can effectively manage a file system provided for data stored in the computer readable storage medium 101.

Moreover, it will be appreciated that a second File Management System (FMS) 110 can effectively supplement and/or augment the file management capabilities of the first FMS 102. Among other things, the second FMS 110 can enhance performance, data integrity and/or error recovery.

More particularly, to achieve better write performance than what can be achieved by using only the first FMS 102, the second FMS 110 can be operable to write input data (D) in a reserved space (e.g., one or more reserved portions) 112 of the file system space 104 as data 115. It should be noted that at a given time, the first FMS 102 may be inoperable to write to the reserved space 112, but it may be operable to write to unreserved space of the file system space 104. As such, the second FMS 110 can be operable to write the input data (D) in the reserved space 112 of the file system space 104 (shown as data 115) when the first FMS 102 is inoperable to write in or to the reserved space 112, but is operable to write in or to one or more other portions of the file system space 104 not reserved for the second FMS 110. The second FMS 110 can also be operable to update the file system organization information 106 to reflect the data 115 as one or more new files F_{d} in the file system. However, it should be noted that the second FMS 110 may be operable to effectively lock access to the organization information 106. By way of example, the second FMS 110 can be operable to update the file system organization information 106 when the first FMS 102 is inoperable to write to the file system organization 106 in order to avoid corrupting the file system organization information 106. This can, for example, be achieved by effectively halting or suspending the first FMS 102 while the second FMS 110 updates the file system organization information 106. As another example, the first FMS 102 may be instructed by the second FMS 110 not to update the file system organization information 106 until further notice is given. Generally, the second FMS 110 can be operable to communicate with the first FMS 102. As such, the second FMS 110 may, for example, be operable to send requests and/or commands to the first FMS 102, to suspend and resume general and/or specific operations of the first FMS 106, reserve and return space of the file system space 104, and so on.

It will be appreciated that the second FMS 110 can also be operable to effectively delay updating the file system organization information 106 in comparison to the first FMS 102, thereby allowing better write performance to be achieved. In other words, the second FMS 110 can also be operable to write, without updating the file system organization information 106, an amount of data to the file system space (i.e., the reserved space 112) that would cause the first FMS 102 to update the file system organization information 106. This means that in comparison to the first FMS 102, the second FMS 110 management system can be operable to perform multiple write operations before updating the file system organization information 106 of the first file management 102. A write operation can, for example, correspond to a stream of input data requiring writing to several nominal units of storage (e.g., clusters, block) of the file system. More generally, the second FMS 110 can be operable to effectively delay updating the file system organization information (or organization information) 106.

It should be noted that second FMS 110 can write data D in the reserved space 112 of the file system space 104 as data 115 without updating the file system organization information 106 but in a manner allowing the data 115 to be later incorporated into the file system. Referring to FIG. 1, second FMS 110 can also write information (or metadata) 117 for data 115 to allow updating the organization information 106 to later incorporate the data 117 into the file system. For example, when input data (D) is to be written as a new file, the file system organization information 106 can be updated to add a new file to the file system. In other words, the second FMS 110 can write metadata 117 that allows updating the file system organization information 106. Those skilled in the art will appreciate that metadata 117 can, for example, be log metadata (or log data) provided for a number of data blocks with enough information to connect them together and represent them as one file in the file system. Generally, metadata 117 can provide information needed to incorporate the data 115 written in the reserved file system space 112.

It will also be appreciated that the metadata 117 can also allow recovery of data 115. Data recovery can, for example, occur when there is system crash before the file system organization information 106 has been updated to incorporate the data written to the reserved file system space 112 which in some conventional file systems could result in loss of data. As such, metadata 117 can be especially useful in cases when the first FMS 102 does not provide an effective mechanism for recovery of data in various situations, such as, for example, a system crash or removal of a removable storage device before the appropriate information (e.g., File system data structures of a FAT file system) has been updated. This means that that the second FMS 110 can also be operable to recognize that data 115 has been written to the reserved file space 112 but it has not been incorporated into the file system. By way of example, after a system crash, the second FMS 110 can check the reserved file space 112 for metadata 117 indicative of data 115 that has not been incorporated into the file system managed by the first FMS 102. The second FMS 110 can then use the information (e.g., log data) provided by the metadata 117 to effectively incorporate the data 115 into the file system, for example, by updating the file system organization information 106 to incorporate the data 115 into an existing file or a new file.

As noted above, the second FMS 110 may also be used to improve data integrity. More particularly, the second FMS 110 can also be operable to write integrity information (or integrity verification information) as a part of the metadata 117 written for data in the file system space 104. As is widely known in the art, integrity information can be provided in various forms including, for example, a hash value determined by or based a hashing algorithm (e.g., a Secure Hash Algorithm (SHA) hash function). Generally, integrity information can be used to verify the integrity of data D in order to avoid data corruption. As such, the second FMS 110 can be operable to write integrity information as a part of metadata 117 for the data 115. Integrity information allows verification of the integrity of the data 115. More particularly, at a given time, the integrity of data 115 can be verified by determining a correct integrity value for the data 115 and comparing it to a stored integrity value (e.g., a hash value).

In addition, file system organization information 106 can be used in conjunction with information needed to update the file system organization information (e.g., log data) to, among other things, reconstruct data and incorporate it into the file system after the integrity of the data has been successfully verified. As such, the second FMS 110 can, for example, be operable to write metadata 117 to include both integrity metadata (or integrity data) and log metadata (or log data). In case of a system failure, second FMS 110 can use integrity metadata to verify the integrity of data 115 and then use the log metadata to incorporate the data 115 into the file system if and when the integrity of the data has been successfully verified. Data verification can be especially useful after a system crash or failure in order to ensure that data has not been corrupted.

It should be noted that the computer readable storage medium 101 can be a removable storage device (e.g., a Flash Drive). As such, the computer readable storage medium 101 can, for example, be used by various computing systems, including computing devices 120 and 130 depicted in FIG. 1. Generally, second FMS 110 can be operable to write data D and its metadata 117 in manner to be effectively invisible to another computing system 130 (e.g., a conventional device) that does not provide a second FMS 110. To further elaborate, although computing system 130 may provide the first FMS 102, if the second FMS 110 does not update the organization information 106, the first FMS 102 would not consider data D as part of the file system and would not recognize the metadata 117.

On the other hand, a second FMS 110 operating in the computing device 120 can be operable to effectively search for metadata indicative of data that has not been incorporated into the file system for a variety of reasons and in different situations, including a system failure or crash, at every startup process. For example, those skilled in the art will know that metadata 117 can be in a form recognizable by the second FMS 110 as metadata. By way of example, second FMS 110 can be operable to write the metadata 117 using a header indicative of data in the reserved file system space 112 that has not been incorporated into the file system. It should also be noted that the second FMS 110 can be operable to delete or modify the metadata 117 after its corresponding data 115 has been incorporated into the file system. Data 115 can be incorporated into the file system by updating the file system organization information to reflect the presence of the data 115 in the file system. The second FMS 110 may also effectively return the control of sections of the reserved space 112 back to the first FMS 102 after data D has been incorporated to the file system. Generally, the second FMS 110 may be operable to dynamically expand or shrink the reserved space 112 of the file system space 104. The second FMS 110 may also be operable to effectively store information regarding the reserved space 112 as reserved space information 150 which can, for example, include the current size and location of the reserved space 112. Generally, an indication or an indicator can be stored in the file system space 104 to effectively indicate management of the file system by the second FMS 110. This indication can, for example, indicate that metadata may be present and there may be additional information including regarding the size and location of reserved space where metadata may still be present. By way of example, the FMS 110 may write this indicator and/or reserved space information 150 to a section of the space 104 where file system information or file system data structures including organization information 106 are kept (e.g., FAT data structures in a FAT file system).

In view of the foregoing, it will be appreciated that in accordance with one described embodiment, a file management system (e.g., FMS 110 depicted in FIG. 1) can be operable to write data to or in one or more portions of a file system space of a file system where data can be organized as files and maintained by another file management system (e.g., FMS 102). The file management system can also be operable to incorporate the written data to the file system for management by the other file management system. In addition, it is apparent that as a method of managing a file system provided in accordance with an embodiment, data can be written to or in one or more portions of a file system space of a file system where data can be organized as files and maintained by a file management system. Thereafter, the written data can be incorporated into the file system for management of the file management system.

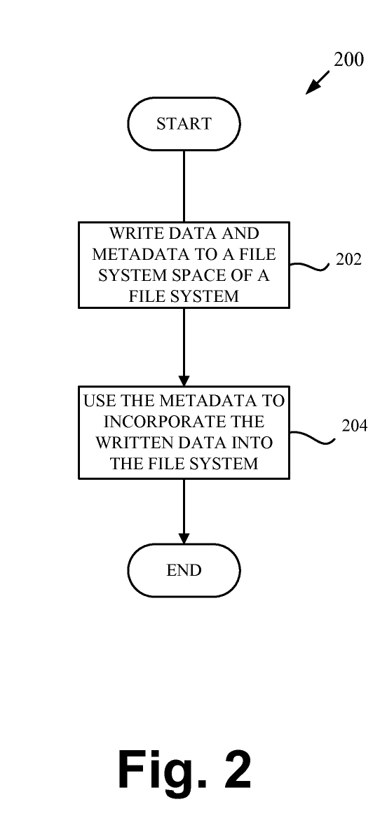

To further elaborate, FIG. 2 depicts a method 200 for managing a file system in accordance with one described embodiment. Method 200 can, for example, be used by the second file management system (FMS) 110 depicted in FIG. 1. Referring to FIG. 2, initially, data and its associated metadata are written to a file system space of a file system. The data and metadata can, for example, be written by the second file management system (FMS) 110 different than a first file management system 102 used to organize and manage data in the file system as one or more files. The first file management system can, for example, be a conventional file system (e.g., a FAT file system). Referring back to FIG. 2, after the data and its associated metadata are written (202) to the file system space of the file system, metadata is used (204) to incorporate the written data into the file system before the method 200 ends. It should be noted that the data and metadata can, for example, be written to one or more reserved portions of the file system space by the second file management system 110 when the first file management system 102 is not operable to write to the reserved portion(s). It should also be noted that metadata can include information (e.g., log data) allowing the written data to become part of the file system managed by the file management system. Generally, information can be stored in a file system space to allow incorporation of data into the file system.

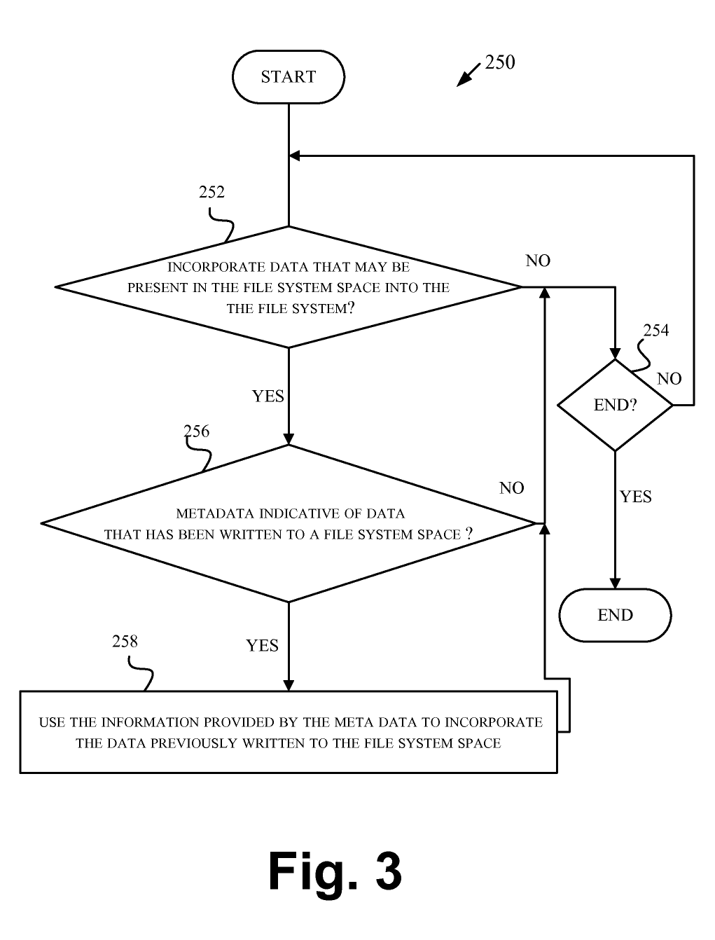

FIG. 3 depicts a method 250 for managing a file system in accordance with another described embodiment. Method 250 can, for example, be used by the (second) File Management System (FMS) 110 depicted in FIG. 1. Referring to FIG. 3, initially, it is determined (252) whether to incorporate written data to the file system. The determination (252) can, for example, represent a design choice, or be made based on various criteria including, for example, the amount or type of data written, or a timing or event consideration. In effect, method 250 can wait for an appropriate time to incorporate the written data into the file system (254) unless it is determined (254) to end the management activities of method 250. Method 250 can, for example, end as a result of system shutdown. However, if it is determined (252) to incorporate the written data to the file system, it can be determined (256) whether metadata is present in the file system. It should be noted that the metadata can be indicative of data that has been written to a file system space but has not been incorporated into the file system. Typically, metadata and its corresponding data are written to a reserved space of the file system space, thereby allowing the metadata and its corresponding data to be identified more efficiently. If it is determined (256) that metadata is present, metadata is used to effectively incorporate (258) data to the file system. It should be noted that the metadata includes information allowing the incorporation of data written in the file system to the file system.

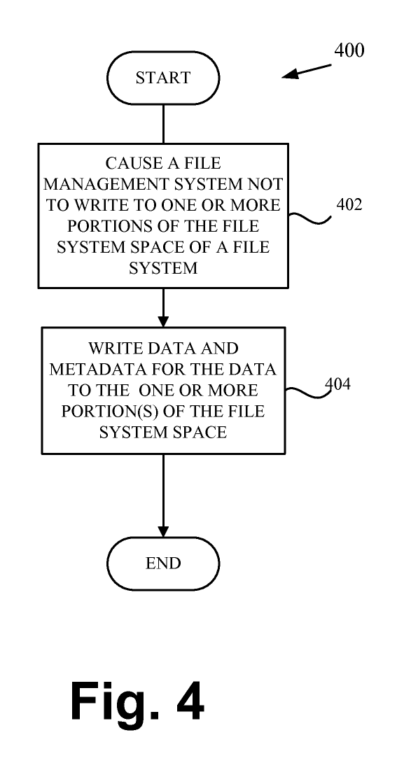

FIG. 4 depicts a method 400 for managing a file system in accordance with yet another described embodiment. Method 400 can, for example, be used by both of the File Management Systems (FMS) 102 and 110 depicted in FIG. 1. Referring to FIG. 4, initially the first file management system is affected to cause (402) it not to write to one or more portions of the file system space of a file system where data can be organized and managed by the file management system as one or more files. The file management system can, for example, be a conventional file system (e.g., a FAT32 file system). Thereafter, the second FMS 110 writes data and metadata (404) to the one or more portions of the file system space without updating the file system information maintained by the file management system. It should be noted that the metadata includes information allowing the file system organization information to be updated later.

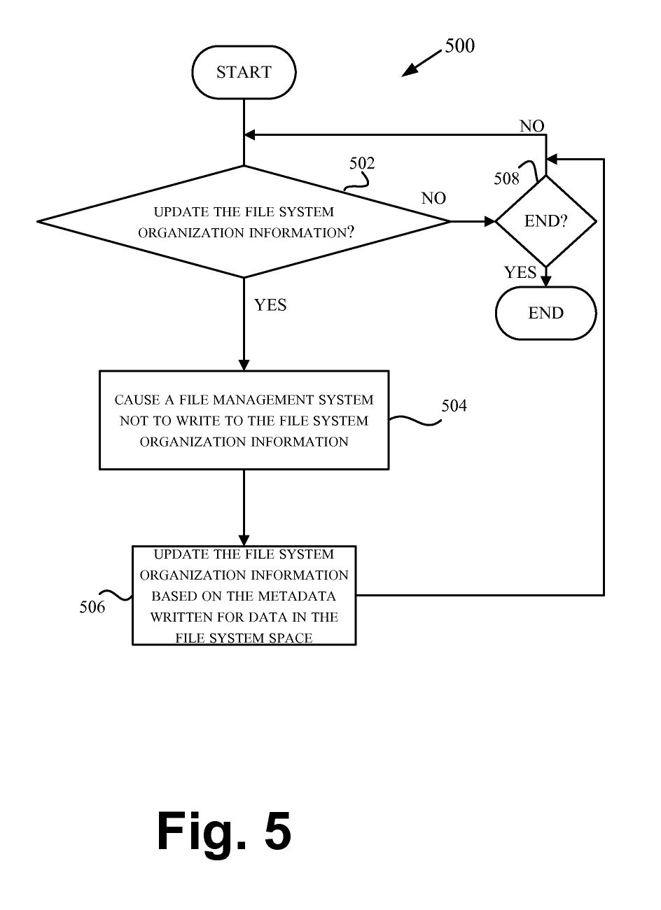

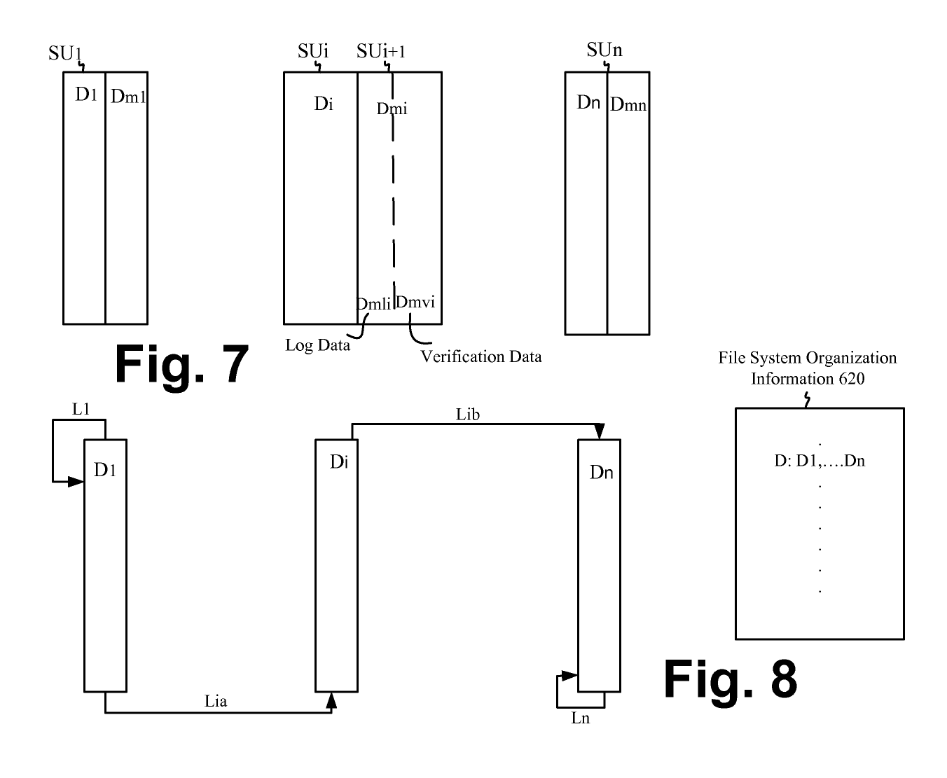

FIG. 5 depicts a method 500 for managing a file system in accordance with still another described embodiment. Method 500 can, for example, be used by the (second) File Management System (FMS) 110 depicted in FIG. 1. Referring to FIG. 5, initially, it is determined (502) whether to update the file system organization information maintained by a file system. Generally, file system organization information can be representative of the organization or logical organization of files maintained by a file management system. File system organization information can, for example, be or include, file system information or data structures of a conventional file system (e.g., a FAT32 file system). Referring to FIG. 5, if it is determined (502) to update the file system organization information, the file management system is caused (504) not to write to the file system organization information. By way of example, operations or normal operations of the file management system can be effectively halted or suspended after causing (504) the file management system not to write to the file system organization information, the file system organization information can be updated (506) based on metadata written data previously written in or to a file system space. Typically, data and metadata are written to a reserved file system space where the file management system is inoperable to write when the data and metadata is written. It should be noted that operations 502, 504 and 506 can, for example, be performed by the FMS 110 depicted in FIG. 7. Method 500 can end after the file system organization information has been updated (506) to effectively incorporate the data into the file system. In effect, method 500 can wait for a determination (502) to update the file system organization information until it is determined (508) to end the management activities of the file system. By way of example, method 500 can end as a result of a system shutdown or after receiving a command to end the management activities, or after file system organization (506) has been successfully updated pending another request to start method 500.

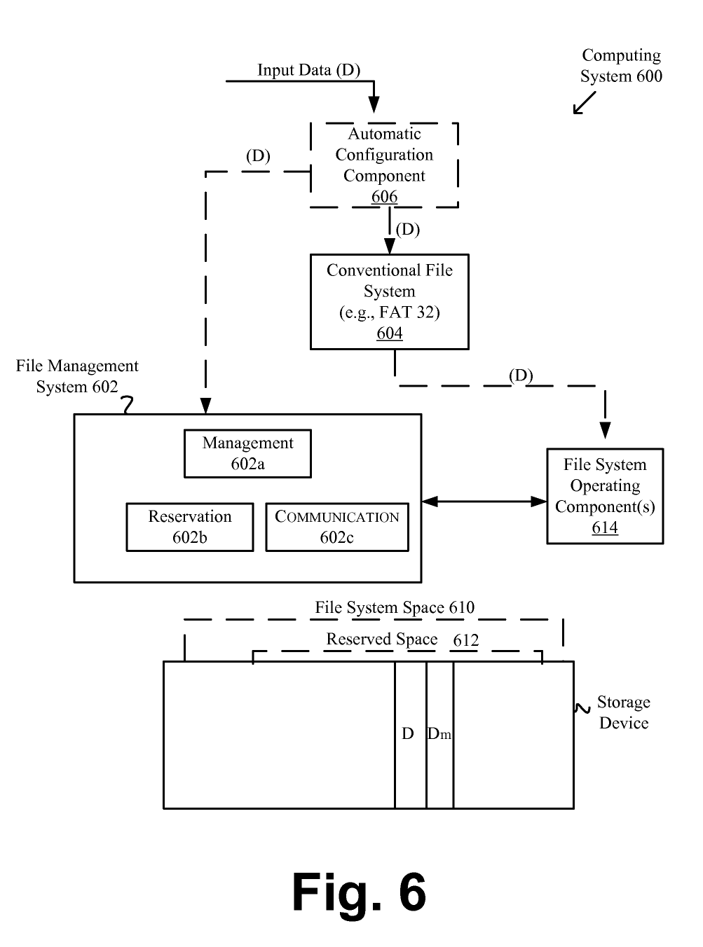

FIG. 6 depicts a File Management System (FMS) 602 provided for a computing system 600 in accordance with one described embodiment. It will be appreciated that the FMS 602 can be effectively provided as an auxiliary or supplemental component to a Conventional File System 604 (e.g., a FAT 32 file system) and effectively augment the capabilities of the Conventional File System (FS) 604. Conceptually, FMS 602 can represent in greater detail a number of components that may be provided for the second File Management System (FMS) 110 (shown in FIG. 1). Referring to FIG. 6, FMS 602 includes a management component (or module) 602a, a reservation module 602b, and a communication module 602c. The management component 602a can effectively control the file management activities of the FMS 602 and can be operable to obtain (e.g., receive) input data (D). It should be noted that input data D may be directly provided to the FMS 602, for example, by an application program (not shown) that interfaces with the FMS 602 in order to write the data (D) into a file system that can be managed by the Conventional File System (FS) 604. Alternatively, data D may be effectively directed (e.g., diverted) to the FMS 602, for example, by an automatic configuration component 606. As such, an automatic configuration component 606 can, for example, be operable to determine, based on one or more criteria whether to provide a request to write the data (D) to the Conventional File System 604 or the FMS 602. By way of example, data (D) can be directed to the FMS 602 when the data is from a streaming video or perceived to be a long stream of data, and so on.

In any case, the management component (or module) 602a of the FMS 602 can obtain the data (D) and write it to a reserved space (or one or more portions) 612 of the file system space 610 normally managed by the Conventional File System 604. The reserved portion 610 of the file system space 612 (or reserved file system space) can be effectively reserved by the reservation module 602b, for example, at the start up time when the computing system 600 starts up or is started for its computing activities. Generally, reservation module 602b can be operable to reserve one or more portions 612 of the file system space 610. At a given time, the reservation module 602b can determine the space portion 612 to be reserved. It should be noted that normal operations of the conventional file system 604 can be effectively suspended or halted when the reservation module 602b is in the process of determining the file system space 610. The operations of the conventional file system 604 can, for example, be effectively suspended or halted by sending a command or request to one or more of its operating components, namely, the file system operating component(s) 614 (e.g., one or more file system drivers). A command or request can, for example, be issued by the reservation component 602b or the management component 602a and communicated to the file system operating component(s) 614 via a communication component 602c operable to interface with the one or more file system operating components 614. Generally, the communication component 602c can be operable to communicate directly or via an interface with one or more file system operating components 614. Those skilled in the art will readily know that a conventional file system driver may have to be modified to enable communication with the communication component 602c of the FMS 602. In addition, in accordance with the embodiment depicted in FIG. 6, a conventional file system driver may be altered to provide the general ability to halt or suspend the operations of the file system and/or to provide more specific abilities, such as, for example, recognizing the reserved space, not writing to the file organization information, and so on.

When the file system operating component 614 has been notified that the file system space 610 has been reserved and the conventional file system 604 has been effectively rendered inoperable to write to the reserved file system space 612, data (D) can be written to the reserved file system space 612. More particularly, the management component 602a can be operable to write the data (D) in the reserved file system space 612. Typically, data (D) is written into multiple (likely several) nominal units of storage (or file system storage units) of a particular conventional file system 604 (e.g., clusters, blocks, clusters of blocks).

To further elaborate, FIG. 7 depicts a number of units of file system storage in a reserved space (or section(s)) of a file system space 610 in accordance with one exemplary embodiment. Referring to FIG. 7, data (D) can be written by a management component 602a (shown in FIG. 6) as data segments D₁ to D_{N} into file system storage units (or storage unit) SU₁ to SUₙ. For a storage unit SUᵢ management component 602a can write data Dᵢ and write its corresponding metadata Dmᵢ in another storage unit, for example, SUᵢ₊₁. It will be appreciated that Dmᵢ can include log metadata (or Dm1ᵢ) and verification metadata (Dmvᵢ) for data Dᵢ. Generally, the log metadata Dm can be used by the management component 602a to incorporate the data segments D₁ to D_{N} as Data D into the file system normally managed by the conventional file system 604. By way of example, data (D) can be incorporated as one or more new files into the file system.

However, referring back to FIG. 6, it should be noted that the management component 602a can effectively postpone the incorporation of data (D) into the file system. Typically, it is desirable to wait at least until an entire file is written, or a current write stream is closed before the management component 602a effectively incorporates data (D) into the file system. It will be appreciated that data (D) can efficiently be incorporated into the file system partly because data (D) is already written into reserved file system space 612 and can be written in a similar form as the conventional file system 604 would write it to the reserved file system space 612. In other words, data can be directly written into the file system space in a form readily available for incorporation into the file system.

Referring now to FIG. 7, those skilled in the art will also appreciate that the log metadata (or Dm1ᵢ) can provide information needed to effectively link the data segments D₁ to D_{N} in a similar manner as they would be linked using the conventional file system 604. In other words, management component 602a (shown in FIG. 6) can be operable to use the log data (Dm1) to effectively link data segments D₁ to D_{N} together as the conventional file system 604 would expect.

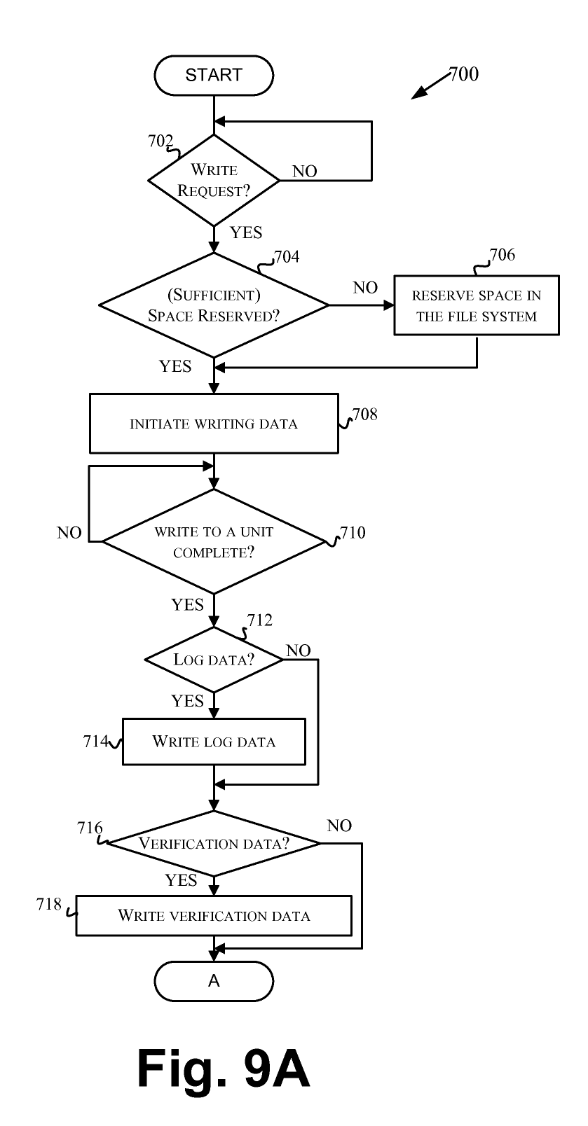

Referring to FIG. 8, data segments D₁ to D_{N} can be linked together using links (L) after data (D) has been completely written in accordance with a described embodiment. In addition, the management component 602a (shown in FIG. 6) can be operable to update the file system organization information (or data) to effectively make data (D) part of the file system managed by the conventional File System 604 (also shown in FIG. 6). It should also be noted that the management component 602a can be operable to delete metadata (Dm) when data (D) has been successfully incorporated into the file system. In any case, metadata Dm may be invisible or effectively rendered invisible to the conventional file system 604 since the conventional file system 604 need not be aware of the presence of metadata.

Referring back to FIG. 6, it should also be noted that management component 602a can also be operable to verify the integrity of data (D) based on verification metadata (Dmvᵢ) (shown in FIG. 7). As noted above, verifying the integrity of data is especially useful in case of a system failure. As such, in case of a system failure, the management component 602a can be operable to search for metadata (Dm) indicative of data (D) that has not been incorporated into the file system, verify based on the verification (or integrity verification) data (Dmvᵢ) provided by the metadata (Dm), the integrity of the data (D) and effectively incorporate the data (D) into the file system or a portion thereof that has been successfully verified. It should be noted that data verification can be performed for each individual portion of data (Dᵢ) based on it own individual integrity data (Dmvᵢ).

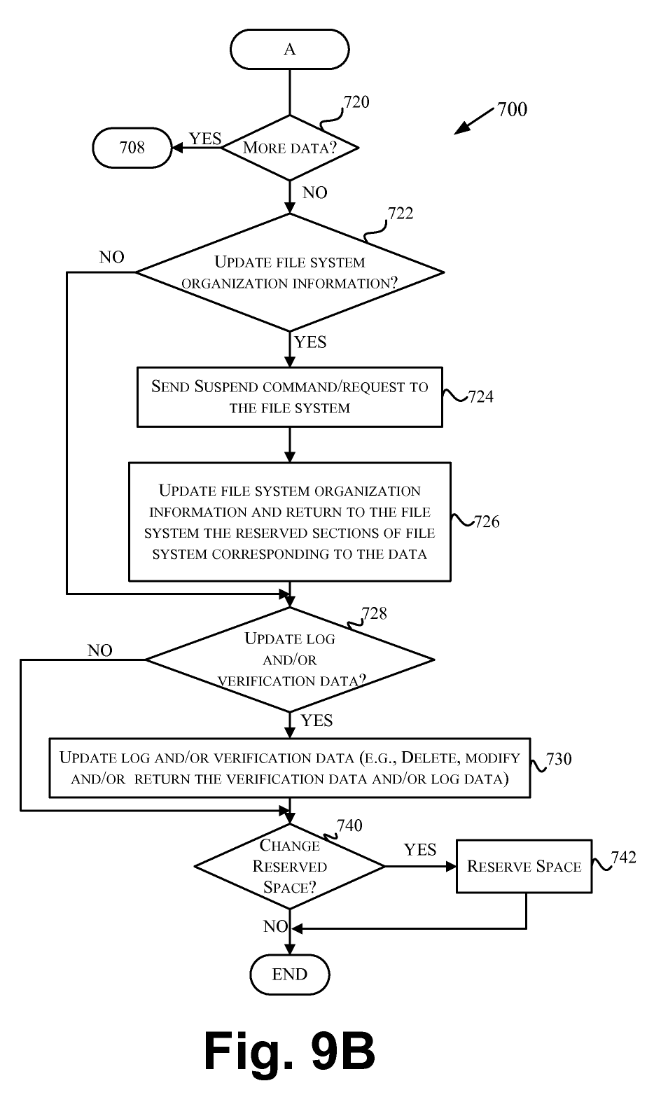

FIGS. 9A-9B depict a method 700 for writing to a file system in accordance with one described embodiment. Method 700 can, for example, be used by the file management system (FMS) 602 depicted in FIG. 6. Referring to FIG. 9A, method 700 can effectively wait for a write request (702). When it is determined (702) that a write request has been received, method 700 can proceed to determine (704) whether space has been reserved in the file system or whether sufficient space has been reserved. Accordingly, method 700 can proceed to reserve (706) space (or sufficient space) in the file system. However, if it is determined (704) that space or sufficient space has been reserved, method 700 can initiate (708) writing data to the reserved space. Specifically, data can be written into a plurality of file system storage units (e.g., nominal units of storage the file system). After writing the data has been initiated (708), it can be determined (710) whether writing to a storage unit of the file system (or a unit) has been completed. When it is determined (710) that writing to a unit has completed, it can be determined (710) whether to write log data. Accordingly, log data can be written (714) when it is determined (712) to write log data. Those skilled in the art will readily appreciate that the determination (712) can, for example, be representative of a design choice or can be made based on a criteria (e.g., type of data and/or application requesting to write data). Similarly, it can be determined (716) whether to write verification data for the data written (710) to the storage unit of the file system.

Referring now to FIG. 9B, method 700 can proceed to determine whether there is more data to be written to the reserved space of the file system (720) and the method 700 can proceed to initiate writing (708) the data to a unit of the file system in a similar manner as discussed above if it is determined (720) that there is more data to be written. On the other hand, if it is determined (720) that there is no more data to write, method 700 proceeds to determine (722) whether to update the file system organization information. If it is determined (722) to update the file system organization information, a suspend or halt operation command/request can be sent (724) to the file system before the file system organization information is updated (726), and the one or more reserved sections of the file system corresponding to the written data can be effectively returned back to the file system. In addition, it can be determined (728) whether to update log and/or verification data. Accordingly, log and/or verification data can be updated (730). By way of example, verification and/or log data can be deleted, modified and/or effectively returned back to the file system. It should be noted that it can be determined (740) whether to effectively change or modify the reserved space of the file system. By way of example, after returning a portion of the reserved file system space to the file system, there may be a need to reserve more file system space. As such, file system space (or sufficient file system space) can be reserved before the method 700 ends.

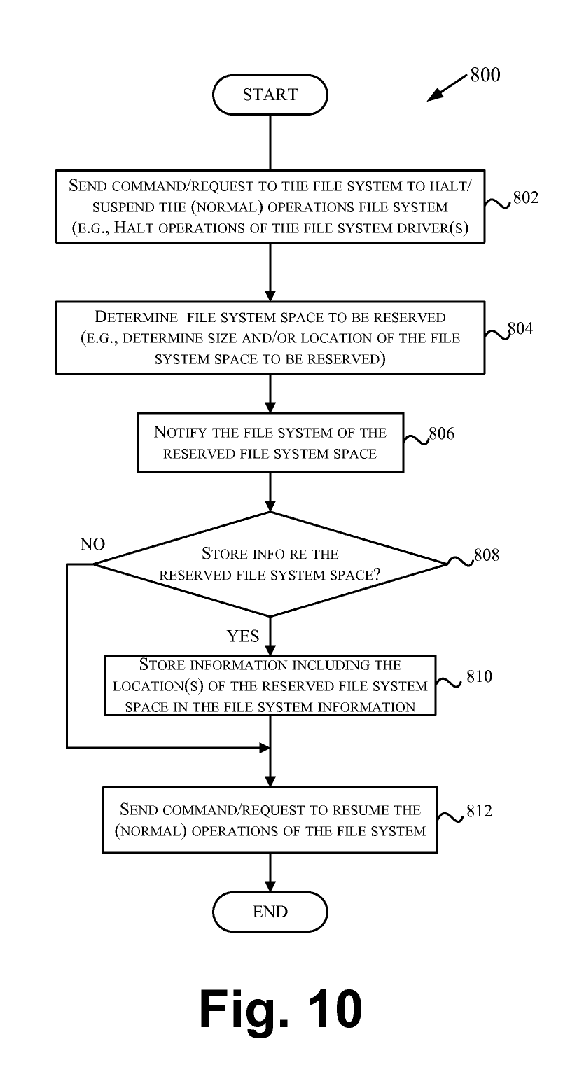

FIG. 10 depicts a method 800 for reserving space in a file system in accordance with one described embodiment. Referring to FIG. 10, initially, a command/request is sent (802) to the file system to halt/suspend the operations (or normal operations) of the file system. By way of example, a command can be sent to one or more file system drivers to effectively halt the operations of the file system. Next, the file system space to be reserved is determined (804). The determination (804) can, for example, include reading the file system data structures in order to determine the size and/or location of the file system space to be reserved. Thereafter, the file systems can be notified of the reserved file system space (806). In addition, a decision (808) can be made as to whether to store information regarding the reserve file system space (806). Accordingly, information, including one or more locations of file system space can be stored (810) as a reserved file system space. This information can, for example, be stored as a part of the file system information as will be readily known to those skilled in the art (e.g., stored in the file system data structures of a file system). The command/request to resume the operations (or normal operations) of the file systems can be sent (812) before the method 800 ends.

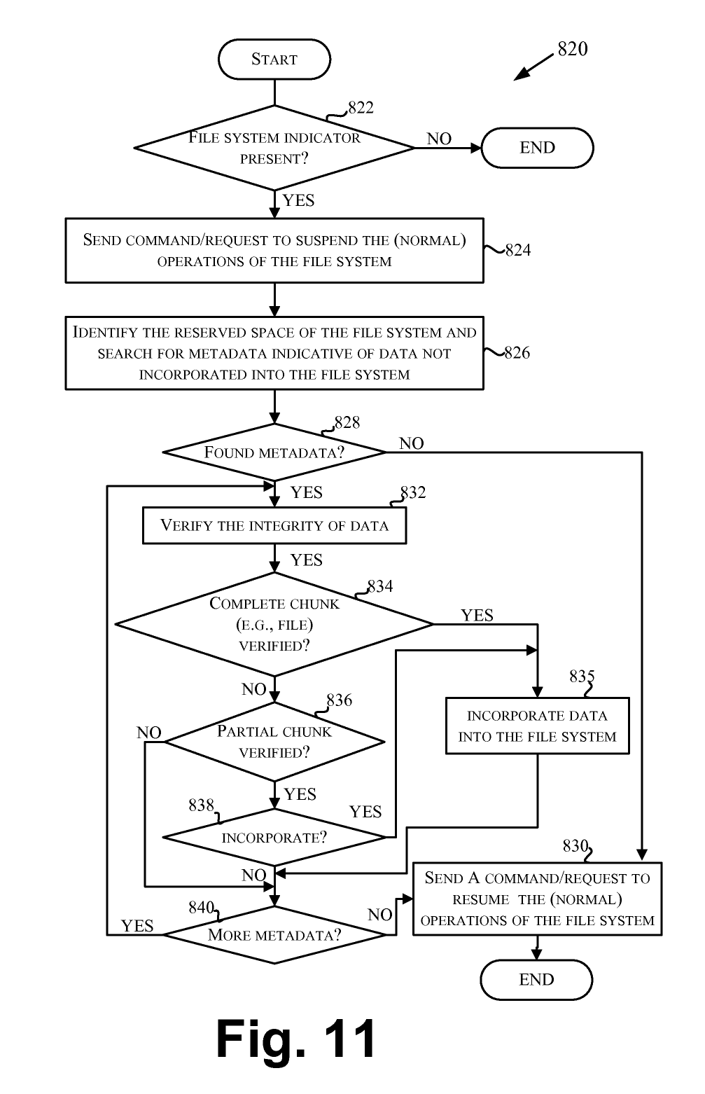

FIG. 11 depicts a method 820 for recovering and incorporating data into a file system in accordance with a described embodiment. Method 820 can, for example, be used by the File Management System (FMS) 602 depicted in FIG. 6. Referring to FIG. 11, initially, it is determined (822) whether there is a file system indicator in the file system space. The file system indicator can indicate that the file system space can potentially have metadata indicative of data that has not been incorporated in the file system. If it is determined (822) that no file system indicator is present, method 820 can end.

However, if it is determined (822) that the file system indicator is present, the command/request is sent to the operating system to effectively suspend or halt the operations (or normal operation) of the file system (824). It should be noted that the file system indicator or additional information can be stored in the file system to effectively identify the reserved file system space.

Next, the reserved file system space is identified and searched (826) for metadata indicative of data in the reserved file system space that has not been incorporated into the file system. Accordingly, the reserved section of the file system can be searched (826) and it can be determined (828) whether metadata indicative of data not incorporated into the file system is present. If it is determined (828) that no metadata is present, a command/request can be sent to the operating system to effectively resume the operations (or normal operations) of the file system before the method 820 ends. However, if it is determined (828) that metadata is present, the integrity of data responding to metadata can be verified (832) based on the integrity verification data provided as a part of the metadata for the data. Thereafter, it can be determined (834) whether a complete “chunk” (or an acceptable amount) of data has been successfully verified. By way of example, it can be determined (834) whether data responding to a complete file or a significant portion thereof has been successfully verified. Accordingly, a complete “chunk” of data can be incorporated into the file system (835). After incorporation of data (835) it can be determined (840) whether more metadata is present for processing (840) and the method 820 can proceed in a similar manner to verify the integrity of data (832). On the other hand, if it is determined (834) that a complete chunk of data has not been successfully verified, it can be determined (836) whether a partial chunk of data has been successfully verified (836). Accordingly, it can be determined (838) whether to incorporate the partial chunk of data into the file system and a partial chunk of the data may be incorporated (835) into the file system. Those skilled in the art will appreciate that the determination (836) can, for example, be made based on one or more pre-determined parameters and/or dynamically based on the type of data or application being considered. Method 820 can proceed to process metadata until it is determined (840) that no metadata can be processed. As a result, the command/request to resume the normal operations of the file system can be sent to the file system (830) before the method 820 ends.

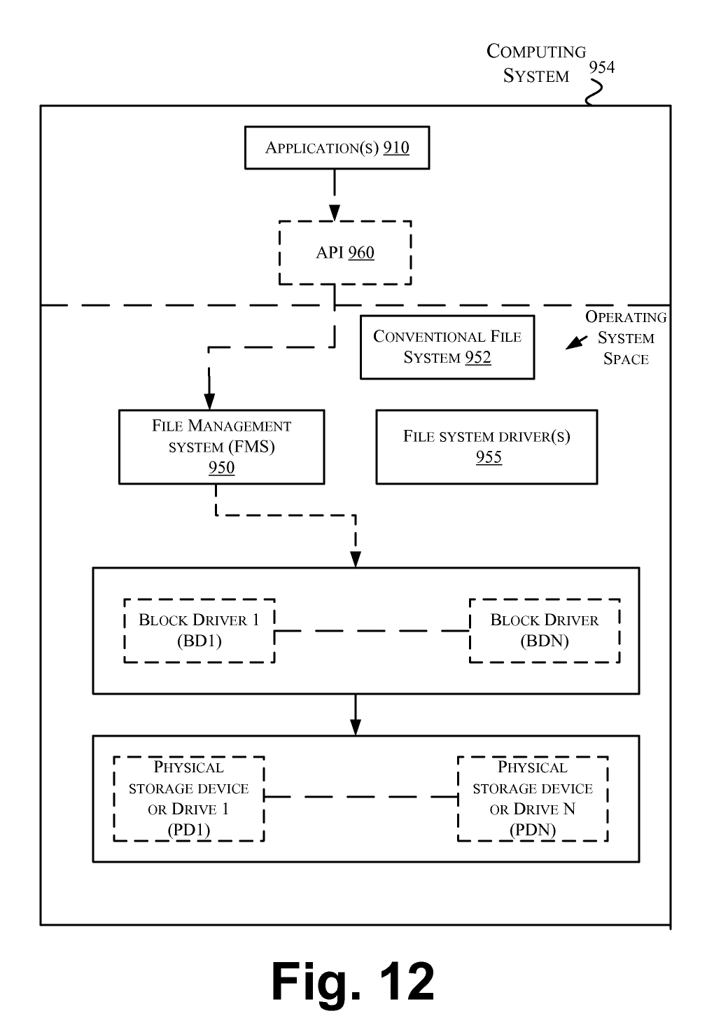

FIG. 12 depicts a File Management System (FMS) 950 provided with a conventional file system 952 for a computing device 954 in accordance with one exemplary embodiment. The File Management System (FMS) 950 can, for example, be the FMS 602 depicted in FIG. 6. Referring to FIG. 12, one or more file system drivers 955 are provided for or provided to support the conventional file system 952. A file system driver 955 can provide conventional functionalities provided by a conventional file system. In addition, the file system driver 955 is operable to communicate with the FMS 950 and provide additional functionalities required to support the file management activities that may be provided in accordance with the described techniques. As such, a file system driver 955 can be an enhanced or modified version of a conventional file system driver. For example, a file system driver 955 can be an enhanced or modified version of a conventional FAT32 driver supporting a conventional FAT32 file system, as will be appreciated by those skilled in art. Those skilled in the art will also appreciate that the FMS 950 can effectively serve as a file system driver for the conventional file system 952. As such, FMS 950 can operate in an operating system space (e.g., kernel space) with one or more file system drivers 955 directly supporting the conventional file system 952. As shown in FIG. 12, one or more computer application programs (or applications) 910 can operate outside the operating system space (e.g., in a user space). Those skilled in the art will readily appreciate that an application 910 can interface with the FMS 950 via an Application Program Interface (API) 960 which can provide a set of functions similar to that provided by an interface to a conventional File System. As such, an application 910 can effectively use the API 960 to perform a variety of file system related functions, including a “write” function to write data to the conventional file system 952. FMS 950 can, in turn, interface with lower interfaces, namely multiple block drivers BD1-BDN in order to write data provided by an application 910 via the API 960 respectively to physical storage devices PD1-PDN.

When the computing operations of the computing device 954 is initiated (e.g., started at system start up) the FMS 950 can effectively suspend the normal operations of the conventional file system 952 by issuing a suspend command to the driver 954, thereby effectively suspending the normal operations of the conventional file system 952 so that data stored by the storage devices PD1-PDN cannot be altered by the conventional File System 952. The FMS 950 can then examine the file system space and reserve space in the file system space based on the free space available on the file system.

By way of example, in a conventional FAT32 file system, the FAT32 driver can be halted and a snapshot of the available clusters can be taken based on the information provided by the File Allocation Table (FAT) as will be appreciated by those skilled in the art. For example, a range with a start and an end value can be reserved. However, it should be noted that the range need not be continuous. As such, a number of clusters in the range already in use by the file system may not be (or be considered) part of the reserved range in the file system space. The reserved range can be extended until a sufficient number of clusters are reserved for use of FMS 950 which can then inform or notify one or more of the file system drivers 955 (e.g., a FAT32 driver) responsible of writing to the file system space of the reserved range. Accordingly, the file system driver(s) 954 will not use (e.g., allocate) the clusters identified in the reserved range but may modify free clusters that have not been reserved and may be already in use by the conventional file system 952 (e.g., a FAT32 operating system). It should be noted that the FAT32 file system data structures need not be modified to reflect the clusters reserved in one or more ranges in the file system space. It should be noted that FMS 950 can store the reserved file system space, for example, by writing a relatively small file in the file system space (e.g., in a FAT32 partition or FAT Allocation Table) to record the reserved space. Storing this information can be especially useful for recovery in case of a system failure. It should also be noted that FMS 950 can also cache a number of clusters into cache memory (not shown) to avoid read operations from the file system space in order to identify the next available reserved storage unit (e.g., next cluster or clusters). FMS 950 can then cause the conventional file system (952) to resume it operations by issuing a resume command to the one or more file system drivers 955 that have been suspended or halted.

When a write stream is opened via FMS 950, a stream descriptor can be made available to an application 910. Application 910 can provide sequential data as it becomes available to be written into the stream identified by the stream descriptor. FMS 950 can write this data with metadata into individual storage units reserved in the file system space for FMS 950. By way of example, a hash value for the data, its length and possibly other information can be written by the FMS 950 to a first available cluster, and subsequently to a second available cluster, and so on.

When the write stream is closed, an incorporation or reconciliation process can take place whereby the data of the stream written into the reserved file system space is effectively incorporated or reconsolidated with the file system. To do this, FMS 950 can again cause the conventional file system 952 to halt its operations by issuing a halt command to one or more of the file system drivers 955. Subsequently, FMS 950 can locate metadata written for the data of the stream and iterate through each metadata of each storage unit (e.g., metadata stored in a cluster) to effectively identify the corresponding one or more data portions stored in one or more other storage units (e.g., clusters of data or data clusters). FMS 950 can then incorporate the data into the file system. By way of example, FMS 950 can update the File Allocation Table of a FAT32 file system, link all the data clusters into a single file, create a new entry in a Directory Table of the FAT32 file system, set a new file name and point the file name to the linked data clusters. It should be noted that the clusters with metadata may be erased by the FMS 950 which can also extend or shrink its reserved range.

A recovery operation can occur when a conventional file system 952 is to become operational after a system failure (e.g., when a FAT32 is mounted). If a file indicative of a reserved range or space of the file system is present in the file system space of a physical storage device (PDi), the FMS 950 can then iterate through all clusters of the reserved range and check to determine if metadata in an expected form is present. If so, the corresponding hash value can be used to verify the integrity of data. Data that has been successfully verified can be recovered by incorporating it into the file system. By way of example, when a “chunk” of data (or an amount of data deemed appropriate) is successfully verified, it may be reconciled to the tail end of an existing file. It should be noted that an application 910 can provide data in atomic units (e.g., one or more complete MPEG frames) to allow for better data recovery as will be appreciated by those skilled in the art.

In view of the foregoing, it will readily be appreciated that the described file can be provided for various file system as described techniques impose no limitation on the file system. As such, the described file system management techniques can, for example be used to effectively manage one or more of the following file systems: a FAT file system, a HFS file system, a Live File system, a Disk file system, a Flash file system, a data base file system, a transactional file system, a network file system, a shared file system, a file system where files are arranged dynamically, a file system where files are arranged dynamically by executable computer program code at runtime, a file system operating under an operating system including one or more of the following: a Microsoft Windows operating system, a Mac operating system, a Solaris operating system, a Unix operating system, a Linux Operating system.

In addition, it will readily be appreciated that the described file system management techniques can be provided for a variety of computing systems and devices, as the described techniques impose no limitation on the computing systems and devices that may work with a file system. As such, the described techniques can, for example, be provided for and used by a portable device operable to store data in a file system, a portable media player operable to store media items as files in a file system, a device with computing capabilities including storing executable code into a file system, and/or a portable phone operable to store data as one or more files in the file system.

In view of the foregoing, it will readily be known that a file management system (e.g., FMS 110) can be provided for a portable device (e.g., a portable media player) with a conventional file system (e.g., a FAT file system). In addition, a removable storage device (e.g., a Flash Drive) can be inserted into the portable device. A conventional system (e.g., a conventional host computer) may not recognize data or metadata in the removable storage device written by the portable device as it may only provide a conventional file system (e.g., a FAT file system). As such, the conventional system may not be able to perform error recovery on the removable storage device when the removable storage device is removed from the portable device and inserted in the conventional the conventional. However, error recovery may still be performed by the portable device when the removable storage device is connected (or reconnected) to the portable device operating with the file management system (e.g., FMS 110).

The various aspects, features, embodiments or implementations of the techniques described above can be used alone or in various combinations. The many features and advantages of the described techniques are apparent from the written description and, thus, it is intended by the appended claims to cover all such features and advantages. Further, since numerous modifications and changes will readily occur to those skilled in the art, the described embodiments should not be limited to the exact construction and operation as illustrated and described. Hence, all suitable modifications and equivalents may be resorted to as falling within the scope of the embodiments.

What is claimed is:

1. In a computing system having at least a file system for storing data files, the file system managed by a first file management system, a method comprising:
using a second file management system different from the first file management system to write data and metadata to a file system space of the file system; and
using at least some of the metadata to incorporate the written data into the file system for management by the first file management system.

2. The method as recited in claim 1, further comprising:
reserving a portion of the file system space as a reserved file system space into which only the second file management system is permitted to write the data and the metadata, wherein the first file management system is permitted to write the data and metadata to an unreserved remaining portion of the file system space; and
writing at least some of the data and metadata to the reserved file system space by the second file management system.

3. The method as recited in claim 2, wherein the using at least some of the metadata to incorporate the written data into the file system for management by the first file management system comprises:
updating file system information by the second file management system, the updated file system information corresponding to the at least some data written by the second file management system to the reserved file system space; and
managing the data written to the file system space by the first file management system using the updated file system information.

4. The method as recited in claim 1, further comprising:
writing integrity data to the file system space, the integrity data associated with the data written to the file system space by the second file management system;
verifying the integrity of the data written to the file system space by the second file management system using the integrity data; and
when the verification is successful, incorporating the data written to the file system space by the second file management system into the file system for management by the first file management system.

5. The method as recited in claim 4, wherein the integrity data is used to verify the written data when one or more of the following occurs: the computing system is booted up and a system failure or error occurs, the system failure or error including at least one of: a system crash and an unexpected system shutdown.

6. The method as recited in claim 2, further comprising:
suspending or halting the first file management system; and
notifying the first file management system of the reserved file system space.

7. The method as recited in claim 1, wherein the metadata includes at least one of the following:
log data including information that allows incorporation of the written data to the file system,
log data including information that allows updating file system organization information pertaining to organization of files in the file system, and
integrity verification data including information that allows verification of integrity of the written data.

8. A computing system, comprising:
a data storage device arranged to store data files as a file system, the file system managed by a first file management system; and
a processor coupled to the data storage device, wherein the processor is configured to write data and metadata to a file system space of the file system using a second file management system different from the first file management system, wherein at least some of the metadata is used by the second file management system to incorporate the written data into the file system after which the written data is managed by the first file management system.

9. The computing system as recited in claim 8, wherein the processor is further configured to reserve a portion of the file system space as a reserved file system space into which only the second file management system is permitted to write the data and the meta data, wherein the first file management system is permitted to write the data and metadata to an unreserved remaining portion of the file system space.

10. The computing system as recited in claim 9, wherein the processor is further configured to use the second file management system to write the data and at least some of the metadata to the reserved file system space.

11. The computing system as recited in claim 10, wherein the processor is further configured to use the second file management system uses at least some of the metadata written to the reserved file system space to update file system information, the updated file system information is used by the first file management system to manage the written data.

12. The computing system as recited in claim 8, wherein the processor is further configured to:
write integrity data associated with the written data in the file system space;
use the integrity data to verify the integrity of the written data; and
incorporate the written data into the file system when the verification is successful.

13. The computing system as recited in claim 12, wherein the integrity data is used to verify the written data when one or more of the following occurs: the computing system is booted up and a system failure or error occurs, the system failure or error including at least one of: a system crash and an unexpected system shutdown.

14. The computing system as recited in claim 8, wherein the first file management system is or includes one or more of the following File Systems: a FAT File System, an HFS File System, a Live File System, a Disk File System, a Flash File System, a data base File System, a transactional File System, a network File System, a shared File System, a File System where files are arranged dynamically, a File System where files are arranged dynamically by executable computer program code at runtime.

15. A computer readable storage medium storing at least executable computer code for managing a file system by a first file management system and a second file management system, wherein the first and second file management systems are different from each other, wherein the executable computer code includes:
executable computer code to write data and metadata to a file system space of the file system using the second file management system, wherein at least some of the metadata is used to incorporate the written data into the file system for management by the first file management system;
executable computer code for reserving a portion of the file system space as a reserved file system space into which only the second file management system is permitted to write the data and the meta data, wherein the first file management system is permitted to write the data and metadata to an unreserved remaining portion of the file system space; and
executable computer code for writing at least some of the data and metadata to the reserved file system space by the second file management system.

16. The computer readable storage medium of claim 15, wherein the computer readable storage medium further includes:
executable computer code for updating file system information of the file system to incorporate the written data into the file system, wherein the file system information is used by the first management system to manage the file system.

17. The computer readable storage medium of claim 15, wherein the computer readable storage medium further includes:
executable computer code to reserve a portion of the file system space as a reserved file system space into which only the second file management system is permitted to write the data; and
executable computer code to write the data and metadata to the reserved file system space by the second file management system.

18. The computer readable storage medium of claim 15, wherein the computer readable storage medium further includes:
executable computer code to write integrity data for the written data in the file system space;
executable computer code to use the integrity data to verify the integrity of the written data; and
executable computer code to incorporate the written data into the file system when the verification is successful.

19. The computer readable storage medium of claim 18, wherein the computer readable storage medium further includes:
executable computer code to use the integrity data to verify the written data when one or more of the following occurs: the computing system is booted up, and a system failure or error occurs, including at least one of: a system crash, and an unexpected system shutdown.

20. A consumer electronic product, comprising:
a data storage device having a file system arranged to store a plurality of data files, the data files being managed by a first file management system;
a processor coupled to the data storage device, the processor configured to execute instructions to perform at least the following operations:
use a second file management system different from the first file management system to write data and metadata to a file system space of the file system, and
use at least some of the metadata to incorporate the written data into the file system for management by the first file management system.

21. The consumer electronic product as recited in claim 20, further comprising:
a data port arranged to facilitate passing of data between the data storage device and an external data source.

22. The consumer electronic product as recited in claim 21, wherein the processor halts the first file management system in order for the consumer electronic product to receive data from the external data source, wherein the second file management system writes the data and associated metadata to the file system space.

23. The consumer electronic product as recited in claim 22, wherein the second file management system updates file system information using at least some of the metadata.

24. The consumer electronic product as recited in claim 23, wherein once the file management information is updated, the processor re-starts the first file management system that then manages the data written to the file system space by the second file management system.

25. The consumer electronic product as recited in claim 22, wherein the data received from the external data source is video data.
